(19) United States
(12) Patent Application Publication
(10) Pub. No.: US 2010/0156942 A1
(43) Pub. Date: Jun. 24, 2010

(54) DISPLAY DEVICE AND METHOD FOR EDITING IMAGES

(75) Inventors: TE-YUAN KUNG, Tu-Cheng (TW); KUAN-HONG HSIEH, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO. LTD., Shenzhen City (CN); HON HAI PRECISION INDUSTRY CO., LTD., Tu-Cheng (TW)

(21) Appl. No.: 12/423,794

(22) Filed: Apr. 14, 2009

(30) Foreign Application Priority Data
Dec. 22, 2008 (CN) 200810306418.X

(51) Int. Cl. G09G 5/00; G06K 9/46

(52) U.S. Cl. 345/661; 345/619; 382/195

(57) ABSTRACT

A method for editing images is provided. The method includes steps of: reading a to-be-displayed image; identifying portions of the read image containing human faces, and defining location(s) of face(s) as face area(s), and the remaining area(s) as non-face area(s); providing an image adjusting menu in response to an input by the user via a user input unit, determining an editing manner in response to a menu item selection, and generating an instruction corresponding to the determined editing manner; editing the face area according to the determined editing manner; displaying the edited image on the display unit; storing the edited image in the storage unit. A display device for editing images is also provided.

### BACKGROUND

1. Technical Field

The present disclosure relates to a display device and a method for editing images.

2. Description of Related Art

There are times when people may like to adjust the appearance of faces in photos. For example, they may like to distort a face to be comically large or small to be funny. Or they may think someone looks fat or skinny and would like to touch up the size of the face to make the person looks better.

In the related art, software is available for the above kind of editing such as Photoshop™, ACDSee™ and so on. For example, if the user wants to reduce a size of face area of the image, the editing steps may include: the user outlining a face in the image; reducing just the face to a desired size; simultaneously, enlarging the rest of the picture to a desired size. This method includes a lot of steps, and although some adjustment is to the face and some to the surrounding area, distortion will still be evident so that the picture just doesn't look as good as it should.

Therefore, what is needed is a display device and method which can edit images according to a user's need.

### BRIEF DESCRIPTION OF THE DRAWINGS

FIG. 1 is a block diagram of a hardware infrastructure of a display device in accordance with an exemplary embodiment.

FIGS. 2A-2C are schematic diagrams showing an image edited by the display device of FIG. 1 in accordance with an exemplary embodiment.

FIG. 3 is a flowchart of an image editing method implemented by the display device of FIG. 1 in accordance with an exemplary embodiment.

### DETAILED DESCRIPTION OF THE EMBODIMENTS

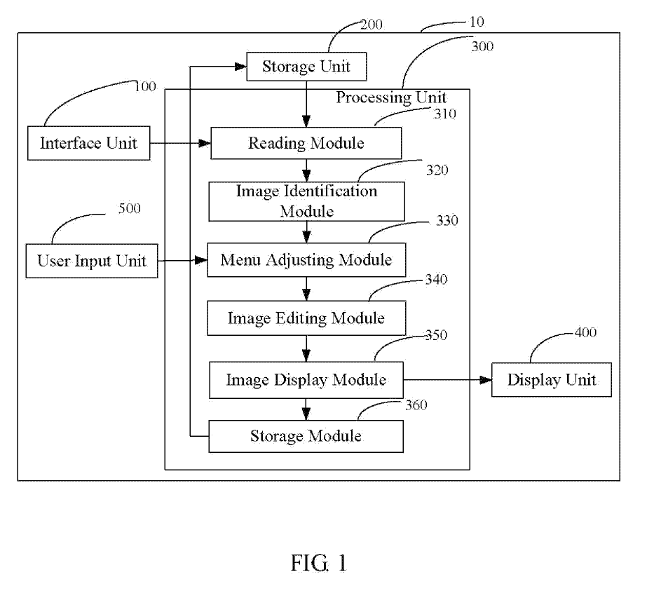

FIG. 1 is a block diagram of a hardware infrastructure of a display device in accordance with an exemplary embodiment. The display device 10 includes an interface unit 100, a storage unit 200, a processing unit 300, a display unit 400, and a user input unit 500. The interface unit 100 is configured to communicate with an external storage device (not shown), for example, such as a digital camera, a flash memory, a mobile hard disk, and so on. The interface unit 100 can be a USB interface, a 1394 interface, and so on. The storage unit 200 is configured to store images of the display device 10. The display unit 400 is configured to display images. The user input unit 500 is configured to receive an input.

The processing unit 300 includes a reading module 310, an image identification module 320, a menu adjusting module 330, an image editing module 340, an image display module 350, and a storage module 360. The reading module 310 is configured to read a to-be-displayed image from the storage unit 100 or the external storage device. The image display module 350 is configured to display the image by the display unit 400.

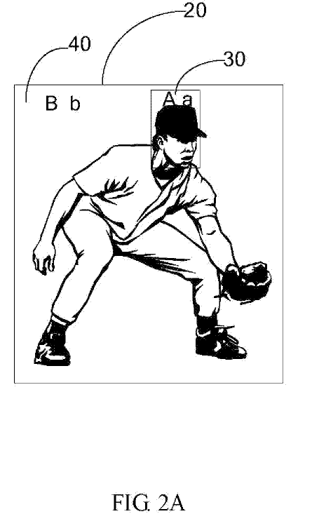

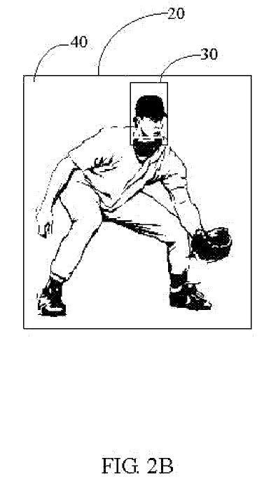

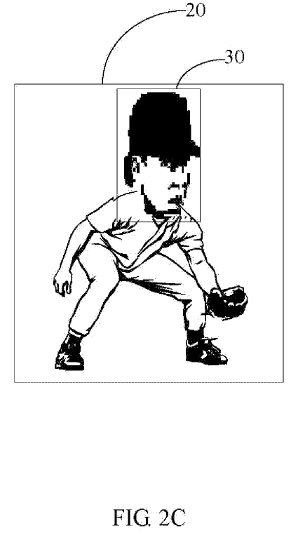

The image identification module 320 is configured to identify portions of the read image containing human faces, and define location(s) containing face(s) as face area(s) and the remaining area(s) as non-face area(s). In the exemplary embodiment, the image identification module 320 detects location of face(s) according to a predetermined algorithm, for example, such as an Adaboost algorithm, and defines the face location(s) as the face area(s) and the remaining area(s) of the image as the non-face area(s). As shown in FIG. 2A, there is a baseball player's image labeled 20, which includes a face location labeled 30. The remaining area of the image is labeled 40. The image identification module 320 identifies the face location 20, and defines the face location 20 as the face area and the remaining area of the image 40 as the non-face area. Also, when dealing with a group photo, the image identification module 320 can identify each of several face locations, define each face location as an individual face area, and define the remaining areas as non-face areas.

The menu adjusting module 330 is configured to provide an image adjusting menu in response to an input by the user via a user input unit 500, determine an editing manner in response to a menu item selection, and generate an instruction corresponding to the determined editing manner. In the exemplary embodiment, the image adjusting menu includes a reducing menu item (R) and an enlarging menu item (E). The reducing menu item (R) is assigned an editing manner for reducing a size of the face area, and the enlarging menu item (E) is assigned another editing manner for enlarging a size of the face area.

The image editing module 340 is configured to edit the face area of the image according to the instruction corresponding to the determined editing manner. For example, the image editing module 340 reduces or enlarges the size of the face area.

FIGS. 2A-2C are schematic diagrams showing an image edited by the display device of FIG. 1 in accordance with an exemplary embodiment. As shown in FIG. 2A, the size of the face area 30 is labeled a, and the size of the non-face area 40 is labeled b. The image editing module 340 edits the face area 30 of the image according to the instruction from the menu adjusting module 320. As shown in FIG. 2B, if the instruction is for reducing the size of the face area 30, the image editing module 340 reduces the face area 30 by m %. Simultaneously, the image editing module 340 enlarges the non-face area 40 by n % to maintain the overall size of the image, wherein n=a*m/b. As shown in FIG. 2C, if the instruction is for enlarging the size of the face area 30, the image editing module 340 enlarges the face area 30 by m %. Simultaneously, the image editing module 340 reduces the non-face area 40 by n % to maintain the overall size of the image, wherein n=a*m/b.

The image display module 350 is configured to display the edited image on the display unit 400.

The storage module 360 is configured to store the edited image in the storage unit 200.

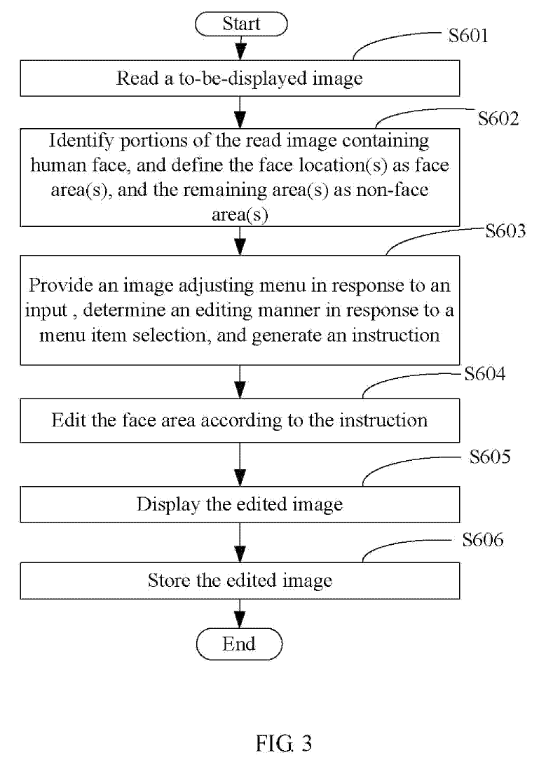

FIG. 3 is a flowchart of an image editing method implemented by the display device of FIG. 1 in accordance with an exemplary embodiment.

In step S601, the reading module 310 reads a to-be-displayed image from the storage unit 200.

In step S602, the image identification module 320 identifies portions of the read image containing human faces, and defines the location(s) includes human face(s) as the face area(s), and the remaining area(s) as the non-face area(s).

In step S603, the menu adjusting module 320 provides an image adjusting menu in response to an input by the user via a user input unit 500, determines an editing manner in response to a menu item selection, and generates an instruction corresponding to the determined editing manner.

In step S604, the image editing module 340 edits the face area of the image according to the instruction corresponding to the determined editing manner, as described above in relation to FIGS. 2A-2C.

In step S605, the image display module 350 displays the edited image on the display unit 400.

In step S606, the storage module 360 stores the edited image in the storage unit 200.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A display device capable of editing images, comprising:
a display unit;
a user input unit;
a storage unit; and
a processing unit comprising:
a reading module capable of reading a to-be-displayed image from the storage unit or an external storage device;
an image identification module capable of identifying portions of the read image containing human faces, and defining the location(s) comprising face(s) as face area(s), and the remaining area(s) of the read image as non-face area(s);
a menu adjusting module capable of providing an image adjusting menu in response to an input by the user via the user input unit, determining an editing manner in response to a menu item selection, and generates an instruction corresponding to the determined editing manner;
an image editing module capable of editing the face area of the image according to the instruction corresponding to the determined editing manner;
an image display module capable of displaying the read image and edited image on the display unit;
a storage module capable of storing the edited image in the storage unit.

2. The display device as in claim 1, wherein the external storage device has been connected with the display device via an interface.

3. The display device as in claim 1, wherein the image identification module is capable of detecting location(s) of human face(s) according to a predetermined algorithm.

4. The display device as in claim 1, wherein the image editing module is further capable of reducing the face area, then enlarging the non-face area to maintain the overall size of the image if the image editing module receives an instruction for reducing a size of the face area.

5. The display device as in claim 1, wherein the image editing module is further capable of enlarging the face area, then reducing the non-face area to maintain the overall size of the image if the image editing module receives an instruction for enlarging a size of the face area.

6. The display device as in claim 3, wherein the predetermined algorithm is an Adaboost algorithm.

7. A method for editing image comprising:
reading a to-be-displayed image;
identifying portions of the read image containing human face(s), and defining the location(s) comprising face(s) as face area(s), and the remaining area(s) of the read image as non-face area(s);
providing an image adjusting menu in response to an input by the user via a user input unit, determining an editing manner in response to a menu item selection, and generating an instruction corresponding to the determined editing manner;
editing the face area of the image according to the instruction corresponding to the determined editing manner;
displaying the edited image;
storing the edited image.

8. The method as described in claim 7, wherein the detecting step further comprising:
detecting location(s) of the human face(s) according to a predetermined algorithm; and
defining the face location(s) as the face area(s) and the remaining area(s) of the image as the non-face area(s).

9. The method as described in claim 7, wherein the editing step further comprising:
reducing the face area, then enlarging the non-face area to maintain the overall size of the image if receiving an instruction for reducing a size of the face area.

10. The method as described in claim 7, wherein the editing step further comprising:
enlarging the face area, then reducing the non-face area to maintain the overall size of the image if receiving an instruction for enlarging a size of the face area.
